(19) United States
(12) Patent Application Publication
(10) Pub. No.: US 2007/0001325 A1
(43) Pub. Date: Jan. 4, 2007

(54) METHOD AND APPARATUS FOR VAPORIZING THERMALLY SENSITIVE SUBSTANCES

(75) Inventors: Gerd Kaibel, Lampertheim (DE); Dirk Neumann, Mannheim (DE)

Correspondence Address: CONNOLLY BOVE LODGE & HUTZ LLP, P.O. BOX 2207, WILMINGTON, DE, 19899-2207, US

(73) Assignee: BASF Aktiengesellschaft, Ludwigshafen (DE)

(21) Appl. No.: 11/424,564

(22) Filed: Jun. 16, 2006

(30) Foreign Application Priority Data
Jun. 17, 2005 (DE) 10 2005 028 032.3

(51) Int. Cl. B01F 3/04

(52) U.S. Cl. 261/153; 261/154

(57) ABSTRACT

Method of vaporizing thermally sensitive substances, wherein the vaporization is carried out in a vaporizer having a porous structured surface and the temperature difference between the product-side surface of the vaporizer and the temperature of the vaporizing product are limited to from 0.1 to 10° C.

The invention relates to a method of vaporizing thermally sensitive substances or mixtures of substances under mild conditions. It further relates to an apparatus for carrying the method of the invention.

According to the prior art, vaporizers of various construction types are used for vaporizing liquids or mixtures of liquids. Customary constructions are, for example, natural convection or forced circulation vaporizers, forced circulation expansion evaporators, climbing film evaporators, falling film evaporators, thin film evaporators or short path evaporators. The geometry of the vaporization surface can be configured in various ways. Shell-and-tube apparatuses in which vaporization takes place either on the inside or the outside of the tubes are wide spread. Furthermore, plate apparatuses having a spirally wound or predominantly flat surface are employed. In the case of thin film evaporators, the interior surface of tubes having a large diameter is utilized, with the liquid being uniformly distributed over the evaporator surface by means of wiping elements.

For cost reasons, preference is given to using natural convection or forced circulation vaporizers. Plate apparatuses offer further cost advantages compared to shell-and-tube apparatuses.

Vaporizers whose surface is provided with porous structures for improving heat transfer represent a particular case. Tubes having a porous coating from UOP (UOP LLC, Des Plaines, Ill., 60017-5017, USA) having the trade name “High-Flux Tubes” or tubes having a microstructured surface from Wieland (Wieland-Werke AG, D-89070 Ulm) having the trade name “Enhanced Boiling Tubes” are an industrially wide spread construction type. Here, either randomly distributed pores (UOP) or porous microstructures applied in a mechanically targeted manner (Wieland) serve, as described, for example, in EP 0607839, to improve heat transfer during vaporization. The porous microstructures or the randomly distributed pores have an action comparable to that of the boiling chips used in the chemical laboratory and trigger the formation of vapor bubbles even at very small temperature differences of from about 2 to 5° C. In the case of a smooth vaporizer surface, larger temperature differences of about 10° C. or more, depending on the geometric configuration of the vaporizer surface, are required. The pore size of the microstructures is in the range from about 1 to 500 microns.

The smaller temperature differences for heat transfer open up better chances for integrated heat systems between the individual process streams and thus serve to reduce energy consumption of overall processes. In the case of mechanical compression of vapors for heating the vaporizer, they can effectively reduce the drive power required as a result of the reduced temperature difference. Such vaporizers are used for basic chemicals such as ethylene, propylene, C₂-, C₃- and C₄-hydrocarbons (LPG, LNG), aromatics such as benzene, toluene and xylene and other hydrocarbons, and for ethylene glycol, methyl tert-butyl ether and ammonia, as indicated, for example, in the company brochures of Wieland-Werke AG and UOP LLC. The substances in question here are small molecules which have relatively high vapor pressures and for which a high vacuum does not have to be employed in the separation in order to avoid thermal decomposition.

In the vaporization of thermally sensitive products, on the other hand, such vaporizers are not used. For the purposes of the present invention, thermally sensitive products are substances which have relatively high boiling points which at atmospheric pressure are above about 150° C. and which have to be vaporized under reduced pressure of, for example, from 0.5 to 100 mbar to avoid damage to the product. Examples of such products are vitamin E, fragrances and other fine chemicals and intermediates. In contrast, apparatuses having particularly smooth surfaces without gaps and voids are customarily used here. The reason is that experience has shown that in the case of thermally sensitive products a longer residence time as a result of a broad residence time distribution leads to reductions in quality. These reductions in quality show up as, for example, undesirable changes in odor or taste, especially in the case of fragrances and flavors, as color changes, for example the yellow discoloration of otherwise colorless products, as changes in the melting point, as a deterioration in the polymerization properties, the formation of high-boiling residues and changes in other product specifications, for example UV absorption, or decomposition of the substances.

It is an object of the invention to find an improved method of vaporizing thermally sensitive products, in which the product can be vaporized at relatively low wall temperatures in a manner which is simple in process engineering terms and without reductions in quality. Furthermore, when the vaporization method of the invention is used in the case of distillation columns, an increase in the operating pressure should be made possible, so that the outlay in terms of apparatus can be reduced as a result of smaller apparatuses (reduction in the column diameter required).

We have accordingly found a method of vaporizing thermally sensitive substances, wherein the vaporization is carried out in a vaporizer having a porous structured surface on the product side and the temperature difference between the product-side surface of the vaporizer and the temperature of the vaporizing product is limited to from 0.1 to 10° C.

A person skilled in the art would not have considered the possibility of using vaporizers having porous structured surfaces on the product side in the handling of thermally sensitive products. To avoid a broad residence time distribution and the reduction in quality to be expected as a result in the case of thermally sensitive products, a person skilled in the art would have made efforts to avoid deep slits on sealing surfaces, for example apparatus flanges, or dead spaces, for example at measurement sensors. The apparatus surfaces are therefore usually preferably made of polished stainless steel, even when there is no corrosive environment.

The porous structured surface which is present according to the invention on the product side of the vaporizer has numerous regularly arranged or random pores. The pore size of the pores, which are approximately circular or have other geometries, is from about 1 to 500 microns. The proportion of pores at the surface can be from about 1 to 80%, preferably from about 10 to 50%. The pore depth corresponds approximately to the pore diameter in the case of an irregular arrangement of the pores. If the pores are introduced mechanically, it is possible to change from an essentially round pore shape to any geometric shapes, for example longitudinal channels. The depth of the pores or depressions is independent of the pore width. Examples of such pore structures are described in EP 0607839, DE 102 10 016 and DE 44 04 357. DE 101 56 374 describes, by way of example, a method of producing such porous structures.

The method of the invention makes it possible to lastingly reduce the wall temperature at which the thermally sensitive products are vaporized. If the vaporization of such products has hitherto been carried out, for reasons of limiting the temperature, at very low pressures of from about 1 to 10 mbar and temperature differences between the product-side surface of the vaporizer and the temperature of the vaporizing product of from 15 to 25° C., this temperature difference can now be reduced to from about 0.1 to 10° C. according to the invention. This corresponds to an achievable reduction in the temperature of the vaporizing product of from about 10 to 30° C. The product quality can thus be lastingly improved.

In an advantageous embodiment, the bottom vaporizer used in the treatment of thermally sensitive products in a distillation column is operated according to the method of the invention, i.e. porous structured surfaces are used in the vaporization. It is advantageously possible here to increase the operating pressure in the distillation column while maintaining the temperature level. This makes it possible to use distillation columns having a smaller diameter for the same requirements.

The effectiveness of the method of the invention and the reduction in the wall temperature made possible here results from the boundary conditions present in each case (substances used, precise configuration of the porous structured surface, type of vaporizer used) and can be demonstrated experimentally by a person skilled in the art. For example, in the case of fragrances and flavors, various trace impurities can, depending on the actual compounds present, lead to a reduction in quality. In the case of undesirable product discolorations, too, the cause is often a mixture of a plurality of compounds which are generally present only in traces. In some cases, catalytic effects of the hot vaporizer surface are observed. It is therefore necessary for the effectiveness of the inventive method in improving the product quality as a result of the reduction in the wall temperature to be determined experimentally. The following procedure has been found to be a practicable method for this purpose. In a discontinuous laboratory experiment, the substance to be tested (the thermally sensitive product which is to be vaporized later) together with a sample of the intended material of construction of the vaporizer (with the appropriate porous structured surface) is treated at the intended vaporization temperature in a stirred vessel. The pressure is set so that no vaporization takes place. Samples of the substance to be tested are taken at various times and tested to determine their quality. The maximum time for which the product can be subjected to thermal stress while still having acceptable quality is determined. The experiment is subsequently repeated at a 15° C. lower temperature and the permissible maximum time is likewise determined. As a guide, it can be considered that the use of a heat exchanger having a porous structured surface has good prospects when the permissible maximum time at the reduced temperature is higher by a factor of at least 2. The longer maximum time takes account of the broader residence time distribution in the case of porous structured surfaces.

To reduce the residence time, preference is given to using falling film evaporators instead of circulation vaporizers when porous structured surfaces are employed, since a higher product quality is particularly readily ensured here because of particularly low residence times of the product in the falling film evaporator. The falling film evaporators can be configured in a customary manner as shell-and-tube apparatuses or as plate apparatuses.

In the case of particularly demanding requirements, preference may also be given to using thin film evaporators equipped with wipers having porous structured surfaces.

### EXAMPLE

The distillation of a thermally sensitive C₂₀-alcohol is carried out in a dividing wall column having 2 side offtakes. At a pressure at the top of 3.4 mbar and a temperature at the bottom of 189.5° C., the optimum column diameter is 3.6 m. Reducing the driving temperature difference in the bottom vaporizer (superheating) by 6° C. makes it possible to double the pressure at the top to 6.8 mbar and results in an optimum diameter of only 3.0 m.

1. (canceled)

2. The method according to claim 5, wherein the vaporizer is a falling film evaporator.

3. The method according to claim 5, wherein the vaporizer is a thin film evaporator.

4. (canceled)

5. A method for vaporizing thermally sensitive substances, comprising:
vaporizing a product in a vaporizer comprising a porous surface on a product side of the vaporizer such that the temperature difference between the surface on the product side and the product is between 0.1° C. and 10° C.

6. The method of claim 2, wherein the falling film evaporator comprises evaporator tubes having a porous structured surface on the product side.

7. A falling film evaporator for vaporizing thermally sensitive substances, said evaporator comprising evaporator tubes having a porous structured surface on a product side of the evaporator, wherein the evaporator is arranged to provide a temperature difference of 0.1° C. and 10° C. with respect to a vaporizing product of the evaporator.
